(19) United States
(12) Patent Application Publication
(10) Pub. No.: US 2024/0334130 A1
(43) Pub. Date: Oct. 3, 2024

(54) Method and System for Rendering 3D Audio

(71) Applicant: Sony Interactive Entertainment Europe Limited, London (GB)

(72) Inventors: Calum Armstrong, London (GB); Danjeli Schembri, London (GB)

(73) Assignee: Sony Interactive Entertainment Europe Limited, London (GB)

(21) Appl. No.: 18/620,012

(22) Filed: Mar. 28, 2024

(30) Foreign Application Priority Data
Mar. 31, 2023 (GB) GB2304820.0

(51) Int. Cl. H04R 5/04; H04S 7/00

(52) U.S. Cl. CPC H04R 5/04; H04S 7/307; H04S 2420/01

(57) ABSTRACT

A method for rendering 3D audio is provided. The method includes: obtaining a to-be-output audio signal, wherein the to-be-output audio signal comprises one or more audio layers; selecting a to-be-filtered audio layer from the one or more audio layers; selecting a rendering Head-Related Transfer Function, HRTF, from a database of HRTFs; applying the rendering HRTF to the to-be-filtered audio layer to generate a filtered audio layer, such that the to-be-output audio signal comprises the filtered audio layer and is a 3D audio signal. In this way, 3D effects are only applied to specific audio layers of an audio signal, thereby efficiently rendering 3D audio without unnecessarily impacting the timbre of the audio signal.

### CROSS-REFERENCE TO RELATED APPLICATION

The present application claims priority from United Kingdom Patent Application No. GB2304820.0, filed Mar. 31, 2023, the disclosure of which is hereby incorporated herein by reference.

### FIELD OF THE INVENTION

The following disclosure relates to methods and systems for rendering 3D audio using one or more Head-Related Transfer Functions (HRTFs). HRTFs are used for simulating, or compensating for, how sound is received by a listener in a 3D space. For example, HRTFs are used in 3D audio rendering, such as in virtual surround sound for headphones.

### BACKGROUND

HRTFs (Head Related Transfer Functions) describe the way in which a person hears sound in 3D and can change depending on the position of the sound source. Typically, in order to calculate a received sound y(f, t), a signal x(f, t) transmitted by the sound source is combined with (e.g. multiplied by, or convolved with) the transfer function H(f).

Detailed and technically correct HRTFs can provide a high sense of externalisation and immersion by accurately simulating the virtual location of a sound such that the listener perceives the rendered audio as they would hear 3D audio in real life. HRTFs are individual to each person, and can described as a sum of different factors dependent on the sound source and the individual, factors such as the size of the head and shape of the ear. Accounting for as many of these factors as possible is necessary to produce the most accurate HRTF, however determining such complex HRTFs and using them to render 3D audio is both computationally demanding and can negatively impact the timbre of the rendered audio.

Accordingly, it is desirable to provide a more computationally efficient way of rendering 3D audio accurately for a user, without impacting the timbre of the rendered audio.

### SUMMARY OF INVENTION

According to a first aspect, the present disclosure provides a method for rendering 3D audio, the method comprising: obtaining a to-be-output audio signal, wherein the to-be-output audio signal comprises one or more audio layers; selecting a to-be-filtered audio layer from the one or more audio layers; selecting a rendering Head-Related Transfer Function, HRTF, from a database of HRTFs; applying the rendering HRTF to the to-be-filtered audio layer to generate a filtered audio layer, such that the to-be-output audio signal comprises the filtered audio layer and is a 3D audio signal.

The to-be-output audio signal is an audio signal intended for playback to a user and includes one or more audio layers. The audio layers are different assets or elements which make up an audio signal, for example a to-be-output audio signal may comprise audio layers corresponding to music or a soundtrack, audio layers corresponding to sound effects such as objects moving and footsteps, and audio layers corresponding to dialogue. The “audio layer corresponding” meaning that if the audio layer corresponding to a soundtrack was isolated and played, or if an audio signal only including the audio layer corresponding to the soundtrack was played, then only the soundtrack would be heard. Multiple audio layers in the audio signal may be played simultaneously and so are audible at the same time when the audio signal is played back—i.e. the sounds of the different assets or elements making up the audio signal are layered on top of each other. The to-be-output audio signal being a 3D signal means at least one audio layer of the signal is rendered in 3D such that, when the to-be-output audio signal is played to a user, the user will perceive the audio layer as originating from a specific virtual location.

By using the method of the first aspect, a rendering HRTF is only applied to specific audio layers of the to-be-output audio signal and an HRTF does not need to be applied to the entire audio signal, thereby rendering a realistic 3D audio signal while using less processing resources, and without affecting the timbre of the audio signal unnecessarily.

The method may be performed in real-time, this is particularly desirable when the method is rendering 3D audio for a video game or a virtual reality application due to the dynamic and interactive nature of these applications. For example, the method may obtain a to-be-output audio signal, select a to-be-filtered audio layer, select a rendering HRTF, and applying the rendering HRTF to the to-be-filtered audio layer all in real-time while a user is playing a video game.

The to-be-output audio signal may comprise a plurality of audio layers.

The method may further comprise: selecting a second to-be-filtered audio layer from the plurality of audio layers; selecting a second rendering HRTF from the database of HRTFs, wherein the second rendering HRTF is different to the first rendering HRTF; and applying the second rendering HRTF to the second to-be-filtered audio layer to generate a second filtered audio layer, such that the to-be-output audio signal is a 3D audio signal comprising the filtered audio layer and the second filtered audio layer.

In this way, the method selects and applies different HRTFs to different audio layers of the to-be-output audio signal. As the rendering HRTF and the second rendering HRTF are different, the complexities of the HRTFs are also different and so the filtered audio layer and the second filtered audio layer have been filtered to different degrees, meaning they will be perceived in 3D space differently even when the filtered audio layer and the second filtered audio layer are played back simultaneously. That is, playing back the to-be-output audio signal may simultaneously play different audio layers with different levels of 3D effects. In an example, when the rendering HRTF is more complex and accounts for a greater number of hearing factors than the second rendering HRTF, then the filtered audio layer will provide more accurate externalisation and localisation than the second filtered audio layer. Rendering 3D audio with higher complexity HRTFs may require more computation than using a simpler HRTF (for example, one with no narrow-band notches) with the same to-be-filtered audio layer. A second audio layer may not require a high degree of externalisation or localisation and so in this case a simpler rendering HRTF may be used to provide the necessary 3D effects without unnecessary computation.

This method may also be performed with more than two audio layers and/or more than two rendering HRTFs. For example, there may be any number of audio layers in the to-be-output audio signal, with a different rendering HRTF applied to each audio layer. Alternatively, the same rendering HRTF may be applied to multiple different audio layers if it is determined that different audio layers should have the same level of 3D effects.

In this way, the importance of providing 3D effects to particular audio layers may be balanced with the required processing resources while also accounting for and minimising any impact on the timbre of an audio layer.

HRTFs of the database of HRTFs may comprise a different subset of hearing factors from a main set of hearing factors in a main HRTF.

The main HRTF represents an HRTF that, when applied to an audio layer, generates a 3D audio signal with high accuracy externalisation and localisation. The main set of hearing factors in the main HRTF may comprise interaural time delay, interaural level difference, low order frequency response features, medium-order frequency response features, and one or more spectral peaks or notches corresponding to a physical feature of the user.

The main HRTF accounting for each of these hearing factors ensures, when applied, the main HRTF provides space and width of a filtered audio layer, as well as the intended high accuracy (i.e. realistic) externalisation and height perception of the layer.

HRTFs of the database of HRTFs comprising a different subset of hearing factors from a main set of hearing factors in a main HRTF may refer to different HRTFs including different types of hearing factors. For example, a first HRTF may include pinna notches while a second HRTF does not.

HRTFs of the database of HRTFs comprising a different subset of hearing factors from a main set of hearing factors in a main HRTF may also refer to different HRTFs including the same types of hearing factors, where the corresponding hearing factors in different HRTFs have different amplitudes. In this way, a rendering HRTF may be selected to further balance the level of timbrel impact and 3D effects provided to the filtered audio layer, as lower amplitude hearing factors may reduce the timbrel impact of the HRTF while also reducing the realism of the 3D effects.

HRTFs and hearing factors may be personalised for an individual user (i.e. the intended listener of the to-be-output audio signal) or may be generic HRTFs and hearing factors determined to be suitable for providing realistic 3D effects for a plurality of users. Using personalised hearing factors for an individual user will provide the most realistic 3D effects for the user. Using the generic hearing factors provides accurate 3D effects and ensures a sound designer can be certain of the output timbre of a filtered audio layer.

The hearing factors of a first HRTF of the database of HRTFs may comprise interaural time delay and interaural level difference.

The first HRTF may further comprise low order frequency response features such as a low frequency notch and/or a high shelf filter or high roll off filter. Low order frequency response features include features of the HRTF which do not vary (or only minimally vary) with either frequency or location.

The first HRTF comprising interaural time delay and interaural level difference means the first HRTF provides a filtered audio layer with space and width, without significantly affecting the timbre of the audio layer. Including the low order frequency response features further enhances the perception of space and width of the filtered audio layer without significantly affecting the timbre.

The hearing factors of a second HRTF of the database of HRTFs may comprise interaural time delay, interaural level difference, and medium-order frequency response features. The medium-order frequency response features may include medium-band boost and/or cut filters within specific regions of the HRTF sphere. Medium-order frequency response features include features of the HRTF which vary with frequency and/or location, though not on the scale of high-order features such as pinnae notches.

The second HRTF also comprising medium-order frequency response features provides more effective externalisation and height perception than the first HRTF without significantly affecting the timbre of the audio layer.

The to-be-filtered audio layer may be selected based on at least one of the following: an application providing the to-be-output audio signal; an output device configured to output the to-be-output audio signal; a pre-set user preference; metadata of the audio layer; or analysis of the audio layer signal.

The application providing the to-be-output audio signal may be the application from which the to-be-output audio signal is obtained. Selecting the to-be-filtered audio layer based on an application may mean the audio layer is selected based on what kind of application provides the signal—such as an audio or video streaming service, or a video game. Selecting the to-be-filtered audio layer based on an application may also mean the audio layer is selected based on an identifier associated with that specific application, for example such that different audio layers are selected as the to-be-filtered audio layers when the applications are different video games.

An output device may be headphone, surround sound speakers, or any other output device suitable for playing the to-be-output audio signal. Selecting the to-be-filtered audio layer based on the output device configured to output the to-be-output audio signal means the audio layers may only be selected to be filtered if the filtered audio layer is suitable for the intended output device.

A user may prefer certain audio layers to be filtered based on different conditions and so can pre-set preferences to ensure these audio layers are always filtered as desired. This saves time and computing resources, while ensuring the rendered 3D audio matches the user's preferences. For example the user may prefer audio layers corresponding to dialogue to always be filtered with high accuracy 3D effects while audio layers corresponding to music to never be filtered, so may set preferences to make certain this is the case. In another example, the user may prefer all audio layers to be filtered to the same or different extent.

The audio layers may comprise metadata indicating whether they should be selected to be filtered by an HRTF. The metadata of the audio layer may be information indicating whether or not the audio layer should be filtered, what type of HRTF should be applied to the audio layer, and/or other audio layer properties such as spatial priority and the virtual position of the audio layer. Selecting an audio layer based on its metadata can save time and processing resources during the rendering of 3D audio. This information may also be available separately to the audio layer, for example in the form of indication information obtained subsequently to obtaining the to-be-output audio signal.

Analysis of the audio layer signal refers to analysing the audio properties of the audio layer itself, for example by analysing the waveform of the audio layer. This analysis may be real time analysis as the audio layer is played (as part of the to-be-output audio signal) or about to be played. Selecting a to-be-filtered audio layer in this manner means that the method for rendering 3D audio is universal and can be used with any to-be-output audio and audio layers, as the audio layer does not need to be configured in any special manner. Analysis of the audio layer may comprise using source separation techniques where the audio signal and/or audio layer includes pre-mixed audio. For example, separating dialogue from background music into distinct audio layers where the dialogue and background music had been pre-mixed into a single audio layer.

It will be apparent that any combination of the above processes may be used together to select the to-be-filtered audio layer.

The to-be-filtered audio layer may be selected based on an audio category of the audio layer.

An audio category refers to a type or classification of the audio layer, for example whether the audio assets of the audio layer correspond to music, ambient noise such as wind or water, dialogue, footsteps etc. Using audio categories of the audio layers means that consistent 3D effects may be added to audio layers of the same type or classification, thereby providing a consistent and immersive experience for the listener—and also increasing the processing efficiency. The audio category of the audio layer may be determined in a variety of ways such as using metadata or analysis of the audio layer signal.

The rendering HRTF may be selected based on at least one of the following: an application providing the to-be-output audio signal; an output device configured to output the to-be-output audio signal; a pre-set user preference; metadata of the to-be-filtered audio layer; or analysis of the to-be-filtered audio layer signal.

Different HRTFs may be more suitable for certain applications than others, therefore selecting a rendering HRTF based on the application providing the to-be-output audio signal can efficiently select an appropriate rendering HRTF for the to-be-filtered audio layer.

Similarly, different HRTFs may be more suitable for different output devices. For example, rendering realistic 3D audio using headphones will require different HRTFs than rendering realistic 3D audio using surround speakers, even when the same to-be-output audio signal is rendered.

Just as a user may prefer certain audio layers to be filtered (discussed above), they may also prefer certain audio layers to be filtered in specific ways using certain rendering HRTFs. The user can pre-set preferences to ensure audio layers are always filtered as desired, thereby providing their preferred 3D audio rendering experience while saving processing resources as additional analysis of the audio layer is not required.

Metadata of the to-be-filtered audio layer may also indicate what HRTF should be applied to the audio layer, saving time and processing resources during the rendering of 3D audio. This metadata may be comprised in the to-be-filtered audio layer or available separately to the to-be-filtered audio layer.

Analysis of the to-be-filtered audio layer signal refers to analysing the audio properties of the to-be-filtered audio layer itself, for example by analysing the waveform of the to-be-filtered audio layer. This analysis may be real time analysis as the to-be-filtered audio layer is played (as part of the to-be-output audio signal) or before it is played. Selecting a rendering HRTF in this manner means that the method for rendering 3D audio is universal and can be used with any to-be-output audio signal and audio layers, as the to-be-filtered audio layer does not need to be configured in any special manner.

The rendering HRTF may be selected based on an audio category of the to-be-filtered audio layer.

In this way, different audio layers of a same audio category may be rendered with consistent degrees of accuracy and 3D effects, thereby improving the user experience. For example, using the same rendering HRTF for all audio layers sharing a dialogue audio category means that, after the rendering HRTF is applied, each of the filtered audio layers will have the same level of externalisation and localisation, ensuring a consistent level of 3D audio rendering for all dialogue.

The plurality of audio layers may comprise a plurality of virtual positions, and the to-be-filtered audio layer and/or the rendering HRTF are selected based on the virtual position of the audio layer.

The virtual position of an audio layer refers to the location that a user is intended to perceive the audio of the audio layer originate from. That is, the position of the virtual sound source of the audio layer. The virtual position of an audio layer may affect to what degree it needs to be filtered by an HRTF to provide accurate 3D audio rendering of the audio layer. For example, sound sources in the same elevation plane as the listener will not need to be filtered in the same manner as sound sources at a different elevation to the listener in order for each source to be localised accurately. Therefore, basing the selection of the to-be-filtered audio layer and/or the selection of the rendering HRTF at least in part on the virtual positions means the to-be-filtered audio layer can be rendered correctly and efficiently.

The plurality of audio layers may comprise a plurality of spatial priorities, and the to-be-filtered audio layer and/or the rendering HRTF are selected based on the spatial priority of the audio layer.

The spatial priority of an audio layer refers to the importance of accurately rendering the audio layer in 3D. For example, a higher spatial priority may indicate that an audio layer should be selected as a to-be-filtered audio layer, and that a higher complexity rendering HRTF with better localisation should be used to filter the to-be-filtered audio layer. In a specific example, an audio layer corresponding to a sudden, directional noise such as a gunshot may have a higher spatial priority than an audio layer corresponding to a omnidirectional noise such as wind. There may be metadata or other indication information that identifies the spatial priority of an audio layer, alternatively the spatial priority of an audio layer may be determined through other means such as analysis of the audio layer signal. The spatial priority of an audio layer may be linked to or determined by an audio category of the audio layer, or may be associated solely with the individual audio layer and unrelated to an audio category of the audio layer.

The to-be-output audio signal may be obtained from a database, a multimedia entertainment system, or a streaming service.

According to a second aspect, the present disclosure provides a system for rendering 3D audio, wherein the system is configured to perform a method according to the first aspect.

According to a third aspect, the present disclosure provides a system for rendering 3D audio, the system comprises: an obtaining unit configured to obtain a to-be-output audio signal, wherein the to-be-output audio signal comprises one or more audio layers; a selecting unit configured to select a to-be-filtered audio layer from the one or more audio layers, and a rendering Head-Related Transfer Function, HRTF, from a database of HRTFs; a rendering unit configured to apply the rendering HRTF to the to-be-filtered audio layer to generate a filtered audio layer, such that the to-be-output audio signal comprises the filtered audio later and is a 3D audio signal.

In some examples of the second and third aspects, the system may be an audio system or an audio-visual system such as a multimedia entertainment console, a game console, or a virtual reality system.

According to a fourth aspect, there is provided a computer program comprising computer-readable instructions which, when executed by one or more processors, cause the one or more processors to perform a method according to the first aspect.

According to a fifth aspect, there is provided a non-transitory storage medium storing computer-readable instructions which, when executed by one or more processors, cause the one or more processors to perform a method according to the first aspect.

### BRIEF DESCRIPTION OF DRAWINGS

Embodiments of the invention are described below, by way of example only, with reference to the accompanying drawings, in which:

FIG. 1A schematically illustrates HRTFs in the context of a real sound source offset from a user;

FIG. 1B schematically illustrates an equivalent virtual sound source offset from a user in audio provided by headphones;

FIG. 2 illustrates headwidth as a hearing factor for an HRTF;

FIG. 3 illustrates pinna features as hearing factors for an HRTF;

FIG. 4A schematically illustrates a to-be-output audio signal before a rendering HRTF has been applied;

FIG. 4B schematically illustrates the to-be-output audio signal after a rendering HRTF has been applied;

FIGS. 5A-5D schematically illustrate several HRTFs for applying to an audio layer;

FIG. 6 schematically illustrates a method for rendering 3D audio.

### DETAILED DESCRIPTION

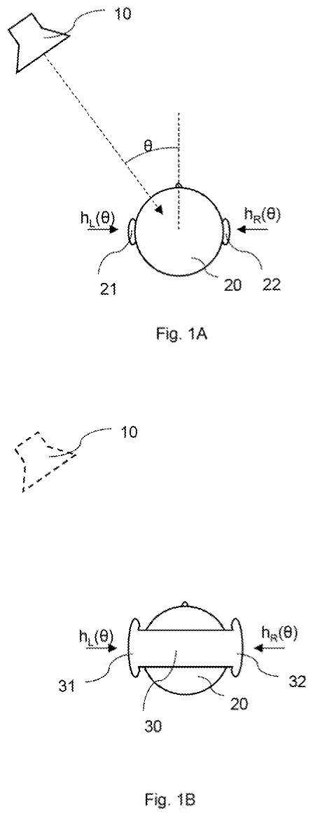

FIG. 1A schematically illustrates HRTFs in the context of a real sound source offset from a user.

As shown in FIG. 1A, the real sound source 10 is in front of and to the left of the user 20, at an azimuth angle θ in a horizontal plane relative to the user 20. The effect of positioning the sound source 10 at the angle θ can be modelled as a frequency-dependent filter hL(θ) affecting the sound received by the user's left ear 21 and a frequency-dependent filter hR(θ) affecting the sound received by the user's right ear 22. The combination of hL(θ) and hR(θ) is a head-related transfer function (HRTF) for azimuth angle θ.

More generally, the position of the sound source 10 can be defined in three dimensions (e.g. range r, azimuth angle θ and elevation angle (φ), and the HRTF can be modelled as a function of three-dimensional position of the sound source relative to the user.

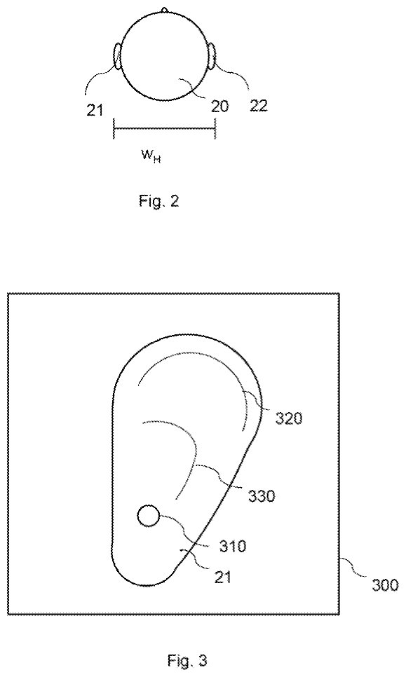

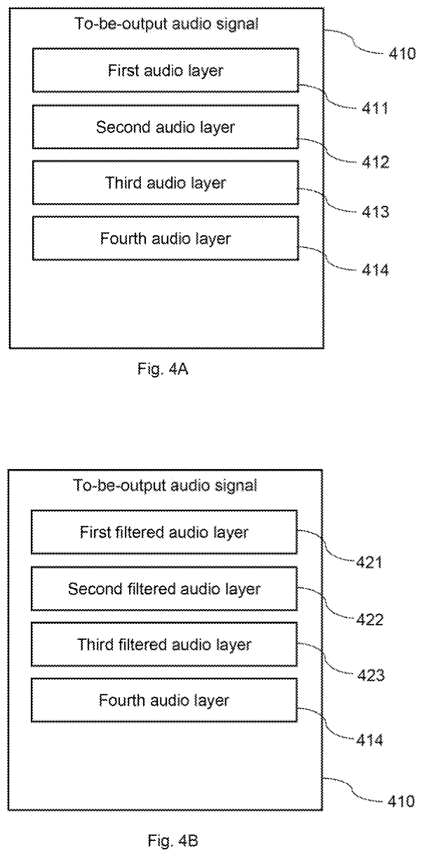

The sound received by the each of the user's ears is affected by numerous hearing factors, including the following examples:
The distance w_{H} between the user's ears 21, 22 (which is also called the “head width” herein) causes a delay between sound arriving at one ear and the same sound arriving at the other ear (an interaural time delay). This distance w_{H} is illustrated in FIG. 2. Other head measurements can also be relevant to hearing and specifically relevant to interaural time delay, including head circumference, head depth and/or head height.
Each of the user's ears has a different frequency-dependent sound sensitivity (i.e. the user's ears have an interaural level difference).
The shape of the user's outer ear (pinna) creates one or more resonances or antiresonances, which appear in the HRTF as spectral peaks or notches with significant amplitude changes at precise frequencies. FIG. 3 illustrates pinna features 320, 330. In this example the pinna features are contours of the ear shape which affect how sound waves are directed to the auditory canal 310. The length and shape of the pinna feature affects which sound wavelengths are resonant or antiresonant with the pinna feature, and this response also typically depends on the position and direction of the sound source. FIG. 3 is referenced again later in the specification when describing how to obtain pinna features in a method of generating an HRTF for an individual user. Further spectral peaks or notches may be associated with other physical features of the user. For example, the user's shoulders and neck may affect how sound is reflected towards their ears. For at least some frequencies, more remote physical features of the user such as torso shape or leg shape may also be relevant.
The complexity of an HRTF feature may also be referred to by its order. That is, a low order feature has lower complexity than a medium or high order feature. The order of an HRTF may correspond to how much the amplitude varies with frequency and/or location of the sound source. For example, a low order feature such as simple interaural level difference will correspond to amplitude changes between the ears which vary smoothly and predictably with location, with frequency having a negligible impact. Meanwhile, a medium-order frequency response feature may be related to torso reflections or head circumference and be represented as a frequency band-boost filter which is gradually applied within a large area of the surrounding location. Finally, high-order frequency response features, such as pinnae notches can be represented with high magnitude amplitude which varies significantly with frequency and location. It will be apparent that the above are merely examples of low, medium, and high-order frequency response features to help illustrate the methods disclosed herein and the invention is not limited to these examples.

Each of these factors may be dependent upon the position of the sound source. As a result, these factors are used in human perception of the position of a sound source. An HRTF that includes a larger amount of hearing factors is generally considered more “complex” than an HRTF that includes less hearing factors, though in practice different some hearing factors (such as a pinna notch) are individually more complex than others (such as interaural time delay).

When the sound source is distant from the user, the HRTF is generally only dependent on the direction of the sound source from the user. On the other hand, when the sound source is close to the user the HRTF may be dependent upon both the direction of the sound source and the distance between the sound source and the user.

FIG. 1B schematically illustrates an equivalent virtual sound source offset from a user in audio provided by headphones 30. Herein “headphones” generally includes any device with an on-ear or in-ear sound source for at least one ear, including VR headsets and ear buds.

As shown in FIG. 1B, the virtual sound source 10 is simulated to be at the azimuth angle θ in a horizontal plane relative to the user 20. This is achieved by incorporating the HRTF for a sound source at azimuth angle θ as part of the sound signal emitted from the headphones. More specifically, the sound signal from left speaker 31 of the headphones 30 incorporates hL(θ) and the sound signal from right speaker 32 of the headphones 30 incorporates hR(θ). Additionally, inverse filters h-1L0 and h-1R0 may be applied to the emitted signals to avoid perception of the “real” HRTF of the left and right speakers 31, 32 at their positions L0 and R0 close to the ears.

In general, HRTFs are complex and cannot be straightforwardly modelled as continuous function of frequency and sound source position. To reduce storage and processing requirements, HRTFs are commonly stored as tables of HRTFs for a finite set of sound source positions, and interpolation may be used for source sources at other positions. An HRTF for a given sound source position may be stored as a Finite Impulse Response (FIR) filter, for example. In one case, the set of sound source positions may simply include positions spaced across a range of azimuth angles θ (without addressing effects of range or elevation). In some cases, elevation may be modelled, for example by using a correcting factor that affects left and right ears symmetrically.

Even with such finite sets, a significant amount of data must be obtained to model the frequency-dependent and position-dependent HRTF for an individual user. More accurate (i.e. providing better localisation) HRTFs require a greater number of hearing factors to be included. However, the increased localisation of the 3D audio may have trade-offs such as needing greater processing resources to filter an audio signal.

Some of the hearing factors can also impact the timbre of an audio signal, changing the resulting audio heard by a listener. Timbre, also known as tone colour or tone quality, refers to the perceived characteristics and quality of a sound or tone. Two sounds may have the same pitch and volume but still sound different to a listener, this is due to the different timbre of the sound. Applying an HRTF with timbre-influencing hearing factors to an audio signal can result in the filtered audio sounding differently to the unfiltered audio signal and to what was intended.

Accordingly, the present invention seeks to provide an efficient way of rendering 3D audio without impacting the timbre of an audio signal.

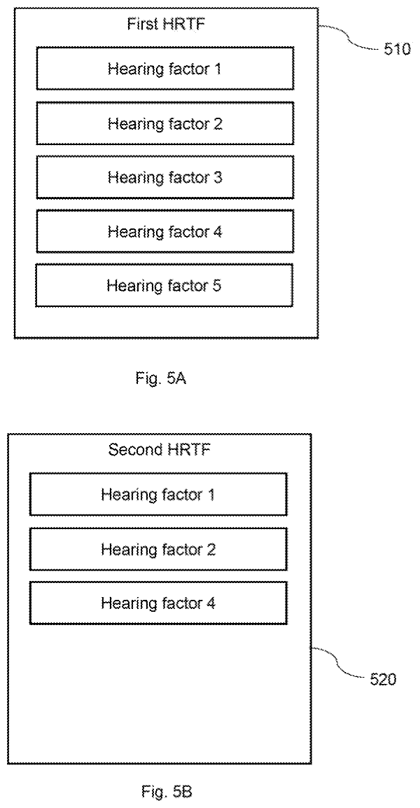

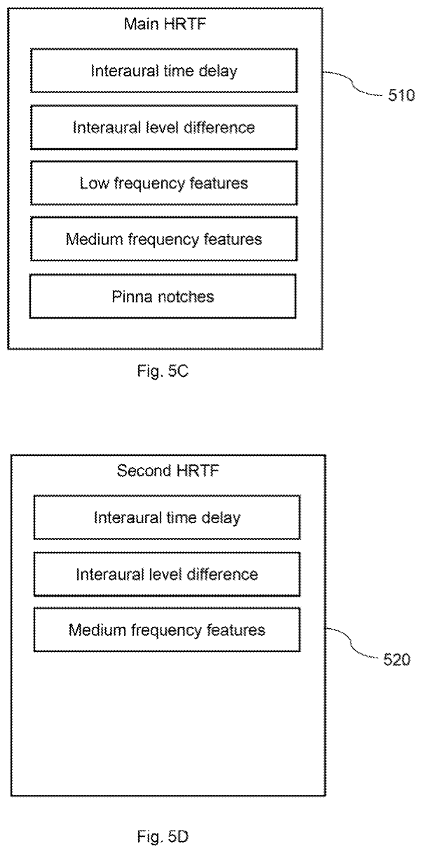

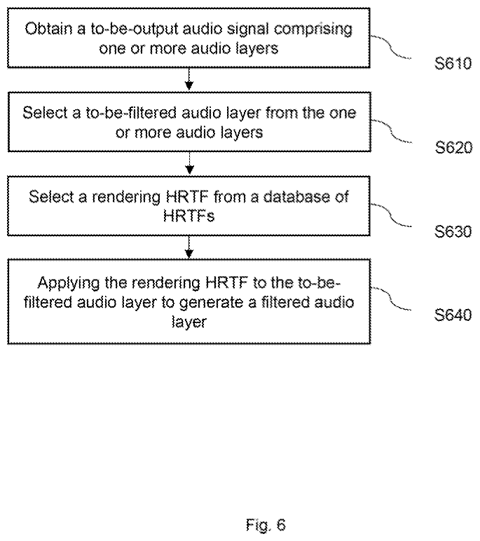

FIG. 6 schematically illustrates a method for rendering 3D audio. FIGS. 4A and 4B, and FIGS. 5A-5D are used as exemplary references to describe an implementation of the method for rendering 3D audio.

In step S610, a to-be-output audio signal is obtained, where the audio signal comprises one or more audio layers.

FIGS. 4A and 4B schematically illustrate a to-be-output audio signal 410 intended for playback to a listener. The audio signal 410 of FIG. 4A comprises a first audio layer 411, second audio layer 412, third audio layer 413, and fourth audio layer 414, with each audio layer representing a different audio asset or group of audio assets. For example, the first audio layer 411 may correspond to dialogue, the second audio layer 412 may correspond to a footstep sound effect, the third audio layer 413 may correspond to ambient sound effects (such as wind), and the fourth audio layer 414 may correspond to music.

In step S620, a to-be-filtered audio layer is selected from the audio layers of the to-be-output audio signal.

The to-be-filtered audio layer may be selected using a variety of methods. For example, based on an application which is providing the to-be-output audio signal 410, an output device configured to output the to-be-output audio signal 410, a pre-set preference of the user who will be listening to the audio signal 410, metadata of the audio layer, an audio category of the audio layer, and/or analysis of the audio layer signal (for example, through real-time analysis of the waveform of the audio layer itself). The metadata may be simple marker for whether or not a HRTF should be applied, the type of HRTF or filtering to be applied, and other audio layer properties such as spatial priority, the virtual sound source and virtual position of the sound source. This information can also be provided in other forms, such as identification information obtained separately from the audio layer.

In step S630, a rendering HRTF is selected from a database of HRTFs. The rendering HRTF is an HRTF to be applied to the to-be-filtered audio layer to render that audio layer in 3D audio form. Differences in the HRTFs will mean the 3D effects of the filtered audio layer will sound different to a user, depending on which HRTF is selected as the rendering HRTF. For example, one HRTF may make a listener perceive the audio of the filtered audio layer as originating from a specific point above the listener and to their left, while applying a different HRTF could result in the same listener perceiving the audio as originating generally from their left without a specific azimuthal direction or elevation being distinguishable. Different HRTFs may be more appropriate depending on the to-be-filtered audio layer.

Similarly to selecting the to-be-filtered audio layer, the rendering HRTF may also be selected through a variety of methods such as being based on application providing the to-be-output audio signal 410, an output device configured to output the to-be-output audio signal 410, a pre-set preference of a user, an audio category of the to-be-filtered audio layer, metadata of the to-be-filtered audio layer, and/or analysis of the to-be-filtered audio layer signal.

In step S640, the rendering HRTF is applied to the to-be-filtered audio layer to generate a filtered audio layer.

Applying the rendering HRTF to the to-be-filtered audio layer typically refers to the process of calculating a received sound y(f, t); an audio layer x(f, t) transmitted by the sound source is combined with (e.g. multiplied by, or convolved with) the transfer function H(f). The filtered audio layer is a 3D audio layer, and so as the to-be-output audio signal 410 comprises the filtered audio layer, this means that the to-be-output audio signal 410 is a 3D audio signal.

The method of FIG. 6 only requires a single audio layer to be selected and have a rendering HRTF applied. However, in other implementations of the method, further audio layers may also be selected as to-be-filtered audio layers, with HRTFs selected and applied to each of them.

FIG. 4B shows the to-be-output audio signal 410 of FIG. 4A after the method of FIG. 6 has been applied, and where several other audio layers of the to-be-output audio signal 410 have also been filtered by HRTFs. Specifically, the first audio layer 411, the second audio layer 412, and the third audio layer 413 have each been filtered using an HRTF(s) and are shown in FIG. 4B as the first filtered audio layer 421, the second filtered audio layer 422, and the third filtered audio layer 423 respectively. No HRTF was applied to the fourth audio layer 414 and so it remains in the to-be-output audio signal 410 of FIG. 4B in an unfiltered, non-3D audio state. It will therefore be apparent that, after application of the present methods, the to-be-output audio signal 410 includes a mixture of filtered (i.e. 3D) audio layers and non-filtered audio layers, so that when the audio signal is output, a portion of the signal will sound externalised and localised to a listener while another portion will not (for example, the non-filtered audio layers might be heard as mono or stereo audio).

The same rendering HRTF may be applied to each of the first, second and third audio layers 411, 412, 413 of the to-be-output audio signal 410. Alternatively, different HRTFs may be applied to different audio layers. For example by applying a first rendering HRTF to the first and second audio layers 411 and 412, with a second rendering HRTF being applied to the third audio layer 413. In another example a first rendering HRTF is applied to the first audio layer 411, a second rendering HRTF is applied to the second audio layer 412, and a third rendering HRTF is applied to the third audio layer 413. This means different degrees of 3D effects can be applied to different audio layers in the to-be-output audio signal 410.

FIGS. 5A to 5D illustrate how different HRTFs may vary from each other due to accounting for different hearing factors, and so provide different 3D effects when applied to a to-be-filtered audio layer.

The first HRFT 510 shown in FIG. 5A comprises five hearing factors (hearing factor 1, hearing factor 2, hearing factor 3, hearing factor 4, and hearing factor 5), while the second HRTF 520 shown in FIG. 5B only includes three hearting factors (hearing factor 1, hearing factor 2, and hearing factor 4). As the first HRTF 510 includes the same hearing factors as the second HRTF 520, and other additional hearing factors, the first HRTF 510 is more complex and provides more 3D effects than the second HRTF 520—for example greater and more accurate externalisation and localisation. However, this may also mean applying the first HRTF 510 to an audio layer requires a greater number of computational resources than applying the second HRTF 520.

Different HRTFs may also vary from each other due to the amplitude of hearing factors. For example, an HRTF-A (not shown) may include the same number and types of hearing factors as an HRTF-B (also not shown). However, in HRTF-A the spectral features associated with one or more of the hearing factor(s) are lower than the corresponding spectral features for the same hearing factor(s) in HRTF-B. The lower amplitude may reduce the timbrel impact of HRTF-A relative to HRTF-B, but may also reduce the realism of the 3D effects.

FIGS. 5C and 5D show specific examples of different HRTFs. The main HRTF 530 shown in FIG. 5C is a high complexity HRTF which, when applied to a to-be-filtered audio layer, provides significant levels of 3D effects. The hearing factors of the main HRTF 530 include interaural time delay, interaural level difference, low frequency features of an HRTF spectrum, medium frequency features of an HRTF spectrum, and pinna notches. By contrast, the second HRTF 520 shown in FIG. 5D only includes a subset of those hearing factors of the main HRTF 530—specifically the interaural time delay, interaural level difference, and medium frequency features hearing factors. Both the main HRTF 530 and the second HRTF 520 confer 3D effects when applied to an audio layer, however the additional hearing factors present in the main HRTF 530 mean it provides highly realistic externalisation and height perception of filtered audio (relative to the second HRTF 520). It will be apparent that the hearing factors described in relation to the main HRTF 530 are examples and that the invention is not limited to using HRTFs with those specified hearing factors, or a subset of those factors.

Having described aspects of the disclosure in detail, it will be apparent that modifications and variations are possible without departing from the scope of aspects of the disclosure as defined in the appended claims. As various changes could be made in the above methods and products without departing from the scope of aspects of the disclosure, it is intended that all matter contained in the above description and shown in the accompanying drawings shall be interpreted as illustrative and not in a limiting sense.

1. A method for rendering 3D audio, the method comprising:
obtaining a to-be-output audio signal, wherein the to-be-output audio signal comprises one or more audio layers;
selecting a to-be-filtered audio layer from the one or more audio layers;
selecting a rendering Head-Related Transfer Function (HRTF) from a database of HRTFs; and
applying the rendering HRTF to the to-be-filtered audio layer to generate a filtered audio layer, wherein the to-be-output audio signal is a 3D audio signal comprising the filtered audio layer.

2. The method of claim 1, wherein the to-be-output audio signal comprises a plurality of audio layers.

3. The method of claim 2, further comprising:
selecting a second to-be-filtered audio layer from the plurality of audio layers;
selecting a second rendering HRTF from the database of HRTFs, wherein the second rendering HRTF is different to the rendering HRTF; and
applying the second rendering HRTF to the second to-be-filtered audio layer to generate a second filtered audio layer, wherein the to-be-output audio signal is a 3D audio signal comprising the filtered audio layer and the second filtered audio layer.

4. The method of claim 3, wherein the rendering HRTF is a personalised HRTF for an individual user and the second rendering HRTF is a generic HRTF for a plurality of users.

5. The method of claim 1, wherein HRTFs of the database of HRTFs comprise a different subset of hearing factors from a main set of hearing factors in a main HRTF.

6. The method of claim 5, wherein the main set of hearing factors in the main HRTF comprises at least one of interaural time delay, interaural level difference, low order frequency response features, medium-order frequency response features, or one or more spectral peaks or notches corresponding to a physical feature of the user.

7. The method of claim 5, wherein the hearing factors of a HRTF of the database of HRTFs comprise interaural time delay and interaural level difference.

8. The method of claim 5, wherein the hearing factors of a HRTF of the database of HRTFs comprise interaural time delay, interaural level difference, and medium-order frequency response features.

9. The method of claim 5, wherein hearing factors of a HRTF of the database of HRTFs are the same type of hearing factors as the hearing factors in the main HRTF.

10. The method of claim 9, wherein at least one hearing factor of the HRTF of the database of HRTFs has a different amplitude to the corresponding hearing factor of the main HRTF.

11. The method of claim 1, wherein the to-be-filtered audio layer is selected based on at least one of: an application providing the to-be-output audio signal; an output device configured to output the to-be-output audio signal; a pre-set user preference; metadata of the audio layer; or
analysis of the audio layer signal.

12. The method of claim 1, wherein the to-be-filtered audio layer is selected based on an audio category of the audio layer.

13. The method of claim 1, wherein the rendering HRTF is selected based on at least one of:
an application providing the to-be-output audio signal; an output device configured to output the to-be-output audio signal; a pre-set user preference; metadata of the to-be-filtered audio layer; or
analysis of the to-be-filtered audio layer signal.

14. The method of claim 1, wherein the rendering HRTF is selected based on an audio category of the to-be-filtered audio layer.

15. The method of claim 1, wherein:
the one or more audio layers comprise a plurality of virtual positions; and
at least one of the to-be-filtered audio layer or the rendering HRTF are selected based on a virtual position of the to-be-filtered audio layer.

16. The method of claim 1, wherein:
the one or more audio layers comprise a plurality of spatial priorities; and
at least one of the to-be-filtered audio layer or the rendering HRTF are selected based on a spatial priority of the to-be-filtered audio layer.

17. The method of claim 1, wherein the to-be-output audio signal is obtained from a multimedia entertainment system.

18. A system for rendering 3D audio, the system comprising:
an obtaining unit configured to obtain a to-be-output audio signal, wherein the to-be-output audio signal comprises one or more audio layers;
a selecting unit configured to select a to-be-filtered audio layer from the one or more audio layers and a rendering Head-Related Transfer Function (HRTF) from a database of HRTFs; and
a rendering unit configured to apply the rendering HRTF to the to-be-filtered audio layer to generate a filtered audio layer, wherein the to-be-output audio signal is a 3D audio signal comprising the filtered audio layer.

19. A non-transitory storage medium storing computer readable instructions which, when executed by one or more processors, cause the one or more processors to perform a method for rendering 3D audio, the method comprising:
obtaining a to-be-output audio signal, wherein the to-be-output audio signal comprises one or more audio layers;
selecting a to-be-filtered audio layer from the one or more audio layers;
selecting a rendering Head-Related Transfer Function (HRTF) from a database of HRTFs; and
applying the rendering HRTF to the to-be-filtered audio layer to generate a filtered audio layer, wherein the to-be-output audio signal is a 3D audio signal comprising the filtered audio layer.
